(19) United States
(12) Patent Application Publication
(10) Pub. No.: US 2026/0196193 A1
(43) Pub. Date: Jul. 9, 2026

(54) DEVICE FOR CHANGING THE TONE AND THE HARMONIC KEY OF A TRUMPET

(71) Applicant: HOXON GAKKI CORPORATION, Chiayi County (TW)

(72) Inventor: Kuo-An Lee, Chiayi County (TW)

(21) Appl. No.: 19/009,446

(22) Filed: Jan. 3, 2025

(51) Int. Cl. G10D 7/10

(52) U.S. Cl. CPC G10D 7/10

(57) ABSTRACT

The present invention provides a device for changing the tone of a trumpet, comprising an acoustic tube, and first to third valves arranged side by side and communicated through different moving channels. The third valve is communicated with a blowing tube. The first to third valves are respectively configured with first to third regulating tubes in a telescopic form. The acoustic tube is curved firstly forward and then backward and is connected with a curved connecting tube. The first valve is configured with a tone tube connecting part extending backward. Tone tubes are provided, having specific curved lengths required by the different tones. The two ends of each tone tube extend forward and are respectively connected between the curved connecting tube and the tone tube connecting part. In this way, by changing tone tubes of different tones for the same trumpet, sounds of different tones can be produced while using the same fingering.

### BACKGROUND OF INVENTION

### 1. Field of the Invention

The present invention relates to an independent tone tube to be flexibly connected between the acoustic tube and the first valve casing of the same trumpet. Each tone tube has different curved lengths for different tones. In this way, by changing tone tubes of different tones, sounds of different tones can be produced while using the same trumpet and the same fingering.

### 2. Description of Related Art

A trumpet is made of a fine and thin round metal tube, with its one-fourth end expanded to form a flare opening. It is provided with three valve devices. When blowing, the user presses the valves using the index finger, the middle finger, and the ring finger of the right hand, and uses the left hand to support the instrument. As the sound of a trumpet is loud and powerful, it can be considered as soprano in brass-wind instruments. A common type is the Tone B^{♭} trumpet, which is a significant instrument used by symphony orchestras, large bands, marching bands, and military bands. Because the sound of trumpets varies greatly, trumpets are also favored by pop music and jazz.

However, each trumpet player has different natural conditions. For example, a person with thick lips may find it more difficult to learn blowing trumpets than those with thin lips. However, this does not necessarily mean fewer achievements. Practice makes perfect. In addition, when blowing brass-wind instruments, the two most important aspects are breath and mouth shape. The breathing method and skill such as using abdominal breathing and force control are the most important. Different mouth shapes can change the air flow and affect the pitch, and breath control can affect one's breathing efficiency and performance in playing the trumpet. Abdominal breathing requires powerful blowing using one's abdomen and is the prerequisite for high pitch. Therefore, when learning to blow brass-wind instruments, the practice of stable long tones and breath control is top priority. Obviously, learning to blow a trumpet is not easy. Especially, it is more difficult to achieve high pitches.

The structure of a trumpet is depicted in FIG. 1 and FIG. 2. It mainly comprises an acoustic tube 1 having a flare opening at the front end. The rear end of the acoustic tube 1 is curved forward and then connected to a first valve 21. A second valve 22 and a third valve 23 are configured beside the first valve 21, and are communicated with the acoustic tube 1 through different channels. Each valve is configured with a key.

In addition, each valve is respectively connected with a first regulating tube 31, second regulating tube 32, and third regulating tube 33. Then, the third valve 23 is connected with a blowing tube 4, which firstly extends forward and then bent backward. The tail end of the blowing tube 4 is connected with a blowing tube connector 41 for connection with a mouthpiece. Thus, when a combination of the keys on each valve is pressed, the whole length of the tube passed by the air flow is changed, and the trumpet can produce sounds of high or low pitches.

Almost any trumpet found in the market is made with only one tone available. At present, most songs of pop music are B^{♭} tone, G tone or F tone. A B^{♭} tone trumpet, designed especially for the soprano section in the band, has higher pitch range than G tone trumpet, which in turn has higher pitch range than F tone trumpet. When playing a trumpet, it requires more air stream and breathing skill to reach the high pitches, thereby making the B^{♭} tone trumpet more difficult to learn, as compared to G tone trumpet and F tone trumpet. Hence, G tone trumpets and F tone trumpets are likely to become the future trends in the music market as they are easier to learn and play. When a B^{♭} tone trumpet is used for G tone or F tone songs, the tones can be produced by using different fingering to press the valves. However, to blow G tone or F tone using the B^{♭} tone trumpet, the player must be familiar with different fingerings. Memorizing individual fingerings for different tones may require long-term training, and is challenging for some trumpet learners. Moreover, as the B^{♭} tone trumpet is limited by its inherent tube length, using it to play other tones is like asking a soprano singer to sing the tones of a contralto. Although G tone or F tone can be played by changing different fingerings, it is still difficult to play some low pitches. Also, learning how to change different fingerings for different tones is more difficult than breath training. Although some trumpet players choose to purchase additional trumpets to play different tones, it is a costly practice, which hinders many players from advancing their skills.

### CONTENT OF THE INVENTION

In order to address the abovementioned problems, the object of the present invention is to provide a device for changing the tone of a trumpet, which comprises an acoustic tube, and first to third valves arranged side by side. The third valve is connected with a blowing tube for connection by a mouthpiece. The first to third valves are respectively configured with adjustable first to third regulating tubes. The tail end of the acoustic tube is connected with a curved connecting tube bending backward. The first valve is configured with a tone tube connecting part that extends backward. Then, tone tubes are provided, having different curved lengths for different tones. The two ends of the tone tubes for different tones are respectively connected between the curved connecting tube and the tone tube connecting part. In this way, by using the same trumpet and the same fingerings, sounds of different tones can be produced.

The present invention solves the above problem by using the following technical scheme:

A device for changing the tone of a trumpet, comprising an acoustic tube, the end of the acoustic tube being curved forward, the acoustic tube being configured with a first valve, a second valve, and a third valve, arranged side by side and communicated through different moving channels, the first valve, the second valve, and the third valve being respectively connected with a first regulating tube, a second regulating tube, and a third regulating tube, the third valve being configured with a curved blowing tube, extending firstly forward and then backward, characterized in that:

One end of the curved acoustic tube extending forward is connected with a curved connecting tube extending backward;

One side of the first valve is configured with a tone tube connecting part extending backward;

A tone tube is provided, having a specific curved length required by different tones, the two ends of the tone tube being flexibly connected between the curved connecting tube and the tone tube connecting part.

The first valve, second valve, and third valve are respectively configured with first valve regulating tube connector, second valve regulating tube connector, and third valve regulating tube connector, respectively provided for telescopic connection by the first regulating tube, second regulating tube, and third regulating tube.

The first valve regulating tube connector, third valve regulating tube connector, and second regulating tube are configured with different tone marks.

In this way, through the present invention, tone tubes of different tones can be changed between the acoustic tube and the first valve, and sounds of different tones can be produced using the same trumpet and the same fingering. This can help reduce the difficulty of trumpet learners in change of fingering.

### BRIEF DESCRIPTION OF THE DRAWINGS

FIG. 1 is a perspective view of a conventional trumpet.

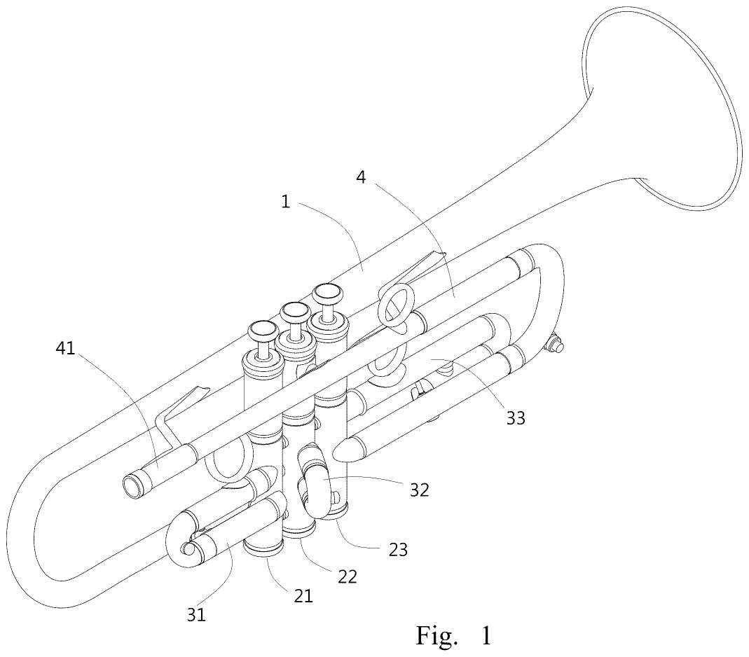

FIG. 2 is a perspective view of a conventional trumpet from another angle.

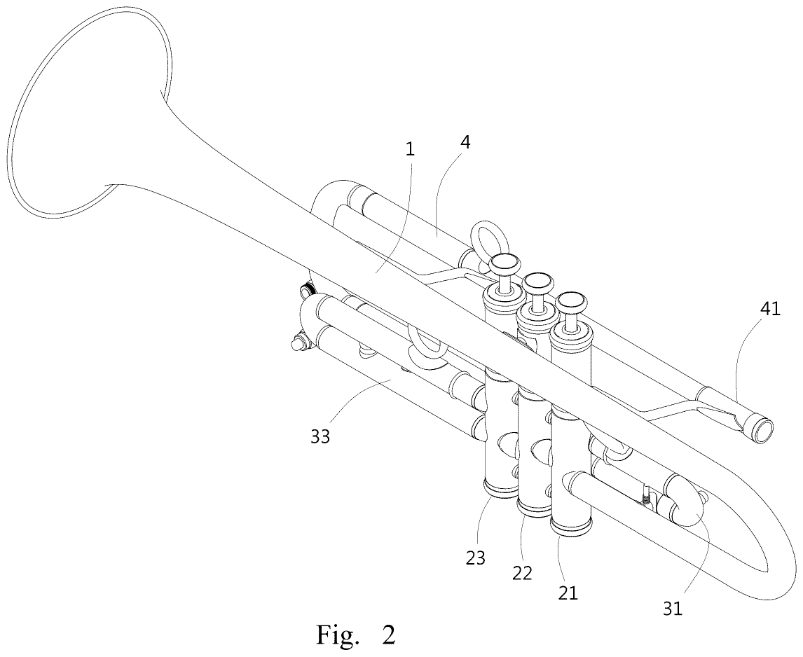

FIG. 3 is an exploded perspective view of a trumpet according to the present invention.

FIG. 4 is an exploded perspective view of a trumpet according to the present invention from another angle.

FIG. 5 is a perspective view of the trumpet of the present invention configured with a B^{♭} tone tube.

FIG. 6 is a perspective view of the trumpet of the present invention configured with a G tone tube.

FIG. 7 is a perspective view of the trumpet of the present invention configured with a F tone tube.

Description of notations in the figures: 1—acoustic tube; 10—curved connecting tube; 21—first valve; 210—tone tube connecting part; 211—first valve regulating tube connector; 22—second valve; 221—second valve regulating tube connector; 23—third valve; 231—third valve regulating tube connector; 31—first regulating tube; 32—second regulating tube; 33—third regulating tube; 4—blowing tube; 41—blowing tube connector; 51, 52, 53—tone tube; E—end connecting part; G, F—tone marks.

### DETAILED DESCRIPTION OF THE INVENTION

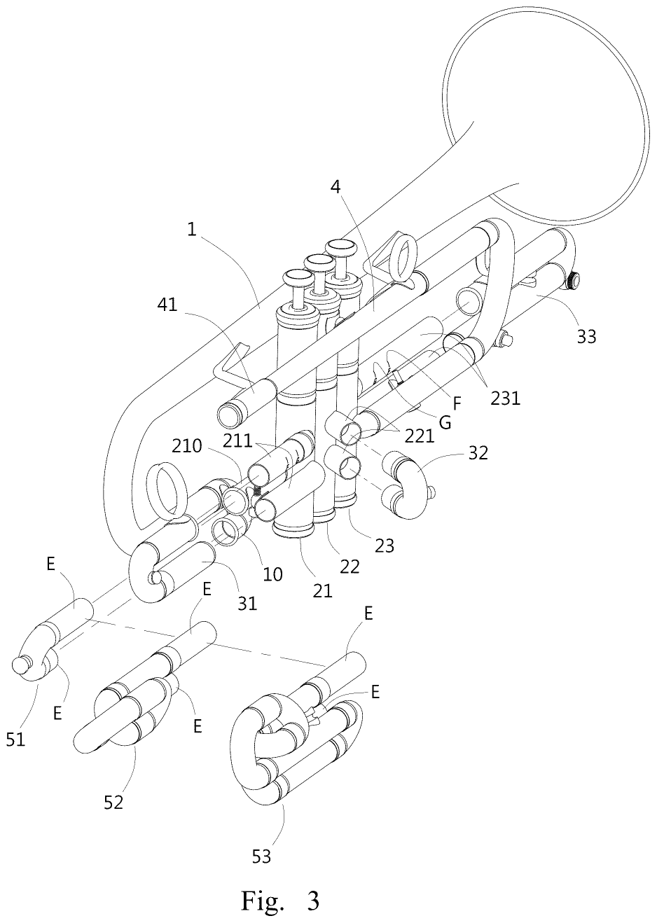

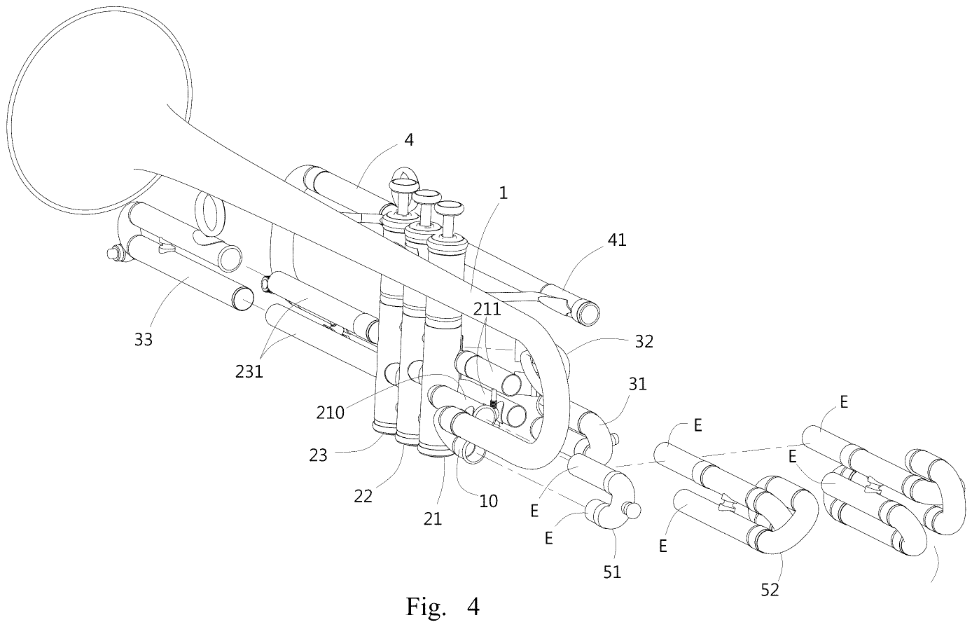

Please refer to FIG. 3 and FIG. 4. The present invention provides a device for changing the tone of a trumpet, comprising an acoustic tube 1 with its front end having a flare opening. The rear end of the acoustic tube 1 is firstly curved forward, and then connected to a curved connecting tube 10 bending backward. A first valve 21, a second valve 22, and a third valve 23 are arranged side by side and communicated through different moving channels. The first valve 21 is configured with a tone tube connecting part 210 that extends backward. The third valve 23 is connected with a blowing tube 4 that firstly extends forward and then bends backward. The tail end of the blowing tube 4 is connected with a blowing tube connector 41 for connection with a mouthpiece.

The above-mentioned first valve 21, second valve 22, and third valve 23 are respectively configured with a first valve regulating tube connector 211, a second valve regulating tube connector 221, and a third valve regulating tube connector 231. The first valve regulating tube connector 211, second valve regulating tube connector 221, and third valve regulating tube connector 231 are respectively connected with a first regulating tube 31, a second regulating tube 32, and a third regulating tube 33, in a flexible manner. Moreover, the first valve regulating tube connector 211, the third valve regulating tube connector 231, and the second regulating tube 32 are configured with tone marks G, F for adjusting different tones, for example: the tone mark G on the third valve regulating tube connector 231 indicates the position to adjust the third regulating tube 33 to produce sound of G tone, and the tone marks F indicates the position to adjust the third regulating tube 33 to produce sound of F tone. Other valve regulating tube connectors 211 and the second regulating tube 32 are also configured with different tone marks G, F.

Between the curved connecting tube 10 configured on the aforementioned acoustic tube 1 and the tone tube connecting part 210 extended on the first valve 21, a tone tube 51 can be connected. For example, the tube depicted in the drawing is a tone tube 51 of B^{♭} tone. The two ends of the tone tube 51 respectively extend forward to form an end connection part E. The two end connecting parts E can be respectively connected to the curved connecting tube 10 and the tone tube connecting part 210. Similarly, as shown in the drawing, the two ends of the tone tube 52 continuously curved to have a curved length for G tone and the two ends of the tone tube 53 continuously curved to have a curved length for F tone also extend forward to form an end connecting part E, and likewise, the two end connecting parts E can be connected between the curved connecting tube 10 and the tone tube connecting part 210.

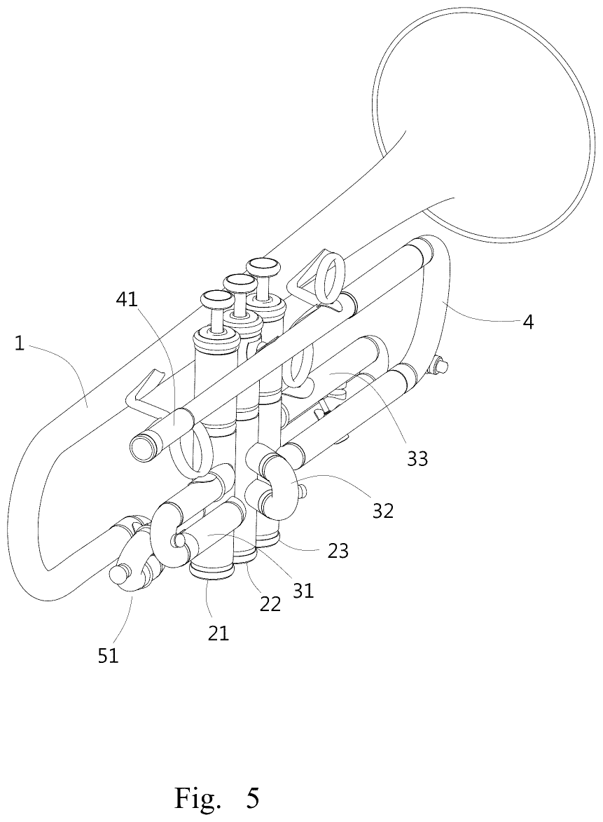

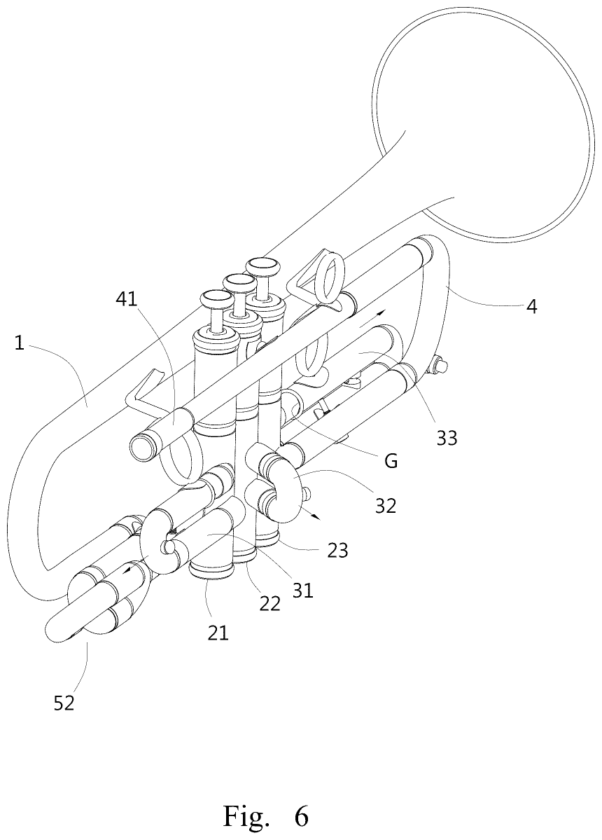

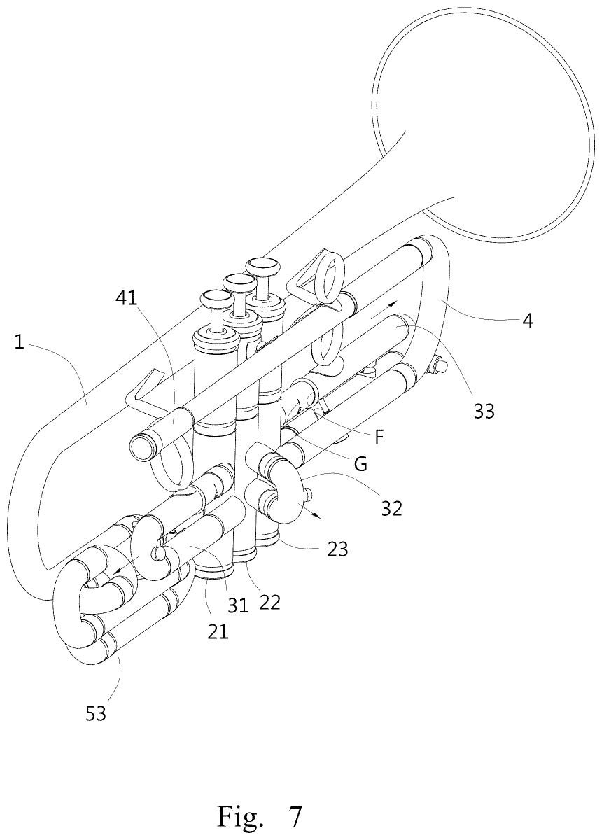

Now referring to FIG. 5, when the tone tube 51 is connected between the curved connecting tube 10 and the tone tube connecting part 210, the trumpet is a B^{♭} tone trumpet; or referring to FIG. 6, when the tone tube 52 is connected between the curved connecting tube 10 and tone tube connecting part 210, and the first to third regulating tubes 31, 32, 33 are pulled outward to the position of the tone mark G, the trumpet becomes a G tone trumpet; or referring to FIG. 7, when the tone tube 53 is connected between the curved connecting tube 10 and the tone tube connecting part 210, and the first to third regulating tubes 31, 32, 33 are pulled outward to the position of tone mark F, the trumpet becomes a F tone trumpet.

Therefore, the tone of the trumpet can be easily changed simply by changing different tone tubes 51, 52, 53 for different tones to be connected between the curved connecting tube 10 and the tone tube connecting part 210, with no need to change the lengths of the acoustic tube 1 and the blowing tube 4. After changing the tones, the trumpet can be blown using the same fingering. In this way, the difficulty for trumpet learners to remember different fingerings for different tones can be reduced.

1. A device for changing the tone of a trumpet comprising an acoustic tube, the end of the acoustic tube being curved, the acoustic tube being configured with a first valve, a second valve, and a third valve, arranged side by side and communicated through different moving channels, the first valve, the second valve, and the third valve being respectively connected with a first regulating tube, a second regulating tube, and a third regulating tube, the third valve being configured with a curved blowing tube, extending firstly forward and then backward;
wherein one end of the curved acoustic tube extending forward is connected with a curved connecting tube extending backward;
wherein one side of the first valve is configured with a tone tube connecting part extending backward; and
wherein a tone tube is provided, having specific curved lengths required by different tones, the two ends of the tone tube being flexibly connected between the curved connecting tube and the tone tube connecting part.

2. The device of claim 1,
wherein the first valve, the second valve, and the third valve are respectively configured with a first valve regulating tube connector, a second valve regulating tube connector, and a third valve regulating tube connector, for telescopic connection by the first regulating tube, the second regulating tube, and the third regulating tube.

3. The device of claim 2,
wherein the first valve regulating tube connector, the third valve regulating tube connector, and the second regulating tube are configured with different tone marks.
